(19) United States
(12) Patent Application Publication
(10) Pub. No.: US 2024/0385804 A1
(43) Pub. Date: Nov. 21, 2024

(54) Integrity Protection

(71) Applicant: Infineon Technologies AG, Neubiberg (DE)

(72) Inventor: Peter PessL, München (DE)

(21) Appl. No.: 18/658,502

(22) Filed: May 8, 2024

(30) Foreign Application Priority Data
May 19, 2023 (DE) 102023113217.2

(51) Int. Cl. G06F 7/58

(52) U.S. Cl. CPC G06F 7/582

(57) ABSTRACT

A solution is provided for generating a sequence of bits based on a seed, wherein a generator is utilized to generate a first set of bits based on the seed, wherein the generator is used to generate a second set of bits, wherein the second set of bits is based on the first set of bits or on a portion of the first set of bits, and wherein the sequence of bits comprises the first set of bits and the second set of bits.

### TECHNICAL FIELD

The present disclosure is generally related to cryptography and is more generally related to techniques for verifying the integrity of long bit strings.

### BACKGROUND

The lattice-based cryptographic schemes Kyber [ABD+21] and Dilithium [LDK+21], which are both chosen by NIST for standardization purposes, utilize a large random matrix \vec{A}. This matrix \vec{A} is specific for each key pair, it is defined during key generation and it is included in both the public key and the private key.

This applies for Kyber as well as Dilithium. In order to cope with limited memory space, only a portion of the matrix \vec{A} is stored: A random seed ρ is generated and stored as part of both the public key and the private key. The matrix \vec{A} is then (re-) compiled in a deterministic manner from this seed ρ whenever needed. In more detail, the seed ρ is used to feed a pseudo-random-number generator (PRNG), to generate a random bit string, which is then subject to a sampling algorithm deriving values following the desired output format, i.e., coefficients within a range [0,q−1]. Kyber and Dilithium use SHAKE as PRNG.

Since the seed ρ is public (i.e., part of the public key), the re-compiled matrix \vec{A} may not have to be secured against side-channel attacks. However, there is still the problem that an attack could inject faults into the matrix \vec{A}, which requires measures ensuring that the matrix \vec{A} is compiled correctly. Another problem is how to find an efficient approach to provide means to verify the integrity of long bit strings.

### SUMMARY

These problems may be addressed using the features of the independent claims. Further embodiments result from the depending claims.

The examples suggested herein may in particular be based on at least one of the following solutions. Combinations of the following features may be utilized to reach a desired result. The features of the method could be combined with any feature(s) of the device, apparatus or system or vice versa.

A method is suggested for generating a sequence of bits based on a seed, wherein a generator is utilized to generate a first set of bits based on the seed, wherein the generator is used to generate a second set of bits, wherein the second set of bits is based on the first set of bits or on a portion of the first set of bits, and wherein the sequence of bits comprises the first set of bits and the second set of bits.

This approach allows verification of the integrity of the sequence of bits by recomputing the second set of bits. Such verification can be used to confirm the integrity of the generator as it may in particular detect (injected) faults.

It is noted that “based on X” is not limiting the reference solely to X; instead it means that it is based “also on X”, i.e., on X and other inputs or X and intermediate results. For example, the first set of bits is based on the seed, wherein the first set of bits may be determined in portions of bits, wherein each subsequent portion of bits is based also on the seed and (e.g., all) previous portions of bits. Accordingly, the second set of bits is based on the first set of bits (i.e., all of its portions) and the seed.

It is further noted that the generator may often be referred to as random-number generator or pseudo-random-number generator. In the context used herein, it is not decisive whether the randomness of the numbers generated is true randomness, pseudo-randomness, or even relates to deterministically computed numbers. The numbers generated may in particular at least seem—to some extent—arbitrary. In this regard, there is no particular requirement to the level of entropy.

Advantageously, the approach described herein can be used in case the sequence of bits, which may in particular be an at least partially random based sequence of bits, is generated or re-generated from any seed. The seed may comprise several bits, whereas the sequence of bits may comprise (substantially) more bits than the seed.

The bits may be generated in successive processing steps, wherein each subsequent step is based on the result of the previous step. In an example, the second set of bits may be generated in (at least) one subsequent step that is based on the first set of bits. As an alternative, the second set of bits may be based on a portion of the first set of bits that resulted from previous steps, whereas the remaining portion of the first set of bits and the second set of bits are the result of the recent (latest) processing step.

According to an embodiment, the generator operates in cycles, wherein each cycle depends on the previous cycle and utilizes a function ƒ. Hence, the generator may operate as a state machine comprising several cycles (i.e., processing steps), wherein each cycle is based on the computation of the previous cycle. The seed is processed in an absorbing phase. The first set of bits and the second set of bits are determined in a squeezing phase of a cryptographic sponge construction.

According to an embodiment, the generator is a pseudo-random-number generator (PRNG), which utilizes an absorbing phase absorbing the seed and a squeezing phase determining the first set of bits and the second set of bits.

According to an embodiment, SHAKE is used as the PRNG. According to an embodiment, the second set of bits are checksum bits to verify the sequence of bits. Hence, the checksum bits can be used to verify the integrity of the generator. This verification can be done, e.g., during decapsulation (in case of Kyber) or during signing (in case of Dilithium).

According to an embodiment, the sequence of bits is verified by re-calculating the second set of bits based on the seed and comparing these re-calculated second set of bits with the checksum bits. According to an embodiment, the second set of bits is computed during a key generation and stored together with the key.

According to an embodiment, the method is used in the context of a lattice-based cryptography method. According to an embodiment, the sequence of bits is determined to compile a matrix for a key pair, which is in particular used in Kyber or Dilithium. According to an embodiment, the method is at least partly conducted on one of the following: a security device, a secured cloud, a secured service, an integrated circuit, a hardware security module, a trusted platform module, a crypto unit, a FPGA, a processing unit, a controller, a smartcard.

Further, a device is suggested for generating a sequence of bits based on a seed, wherein the device is arranged to execute the following steps: generating a first set of bits based on the seed, and generating a second set of bits, wherein the second set of bits is based on the first set of bits or on a portion of the first set of bits, wherein the sequence of bits comprises the first set of bits and the second set of bits.

The device may be or it may utilize any processing unit for conducting such steps. This processing unit can comprise at least one, in particular several means that are arranged to execute the steps of the method described herein. The means may be logically or physically separated; in particular several logically separate means could be combined in at least one physical unit. The processing unit may comprise at least one processor and/or microcontroller (MCU). According to an embodiment, the device is one of the following or it comprises at least one of the following: a security device, a secured cloud, a secured service, an integrated circuit, a hardware security module, a trusted platform module, a crypto unit, a FPGA, a processing unit, a controller, a smartcard.

Also, a computer program product is provided that is loadable into a memory of a digital processing device, comprising software code portions for performing the steps of the method described herein.

### BRIEF DESCRIPTION OF THE FIGURES

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a schematic diagram of states of a Sponge construction used in SHAKE.

FIG. 2 shows a schematic diagram visualizing an exemplary embodiment of determining additional check bits.

FIG. 3 shows an exemplary diagram visualizing steps of how an integrity of a long bit string can be verified.

FIG. 4 shows an exemplary arrangement of a processing device comprising a CPU, a RAM, a non-volatile memory, a crypto module, an analog module, an input/output interface and a hardware-random number generator.

FIG. 5 shows an alternative arrangement with a hardware security module (HSM).

### DETAILED DESCRIPTION

Solutions described herein allow for a cost-efficient approach to detect fault injection during the compilation of the matrix \vec{A}. In particular, the correct execution of the PRNG, turning the seed ρ into a long pseudo-random bitstring, is ensured. Hence, the PRNG can be run on an unprotected device, e.g., an accelerator.

This is achieved utilizing the PRNG to generate more output bits than necessary. These additional output bits are then used as a checksum (i.e., checksum bits) to verify the correct computation of the (entire) PRNG output.

As an option, the checksum bits can be computed during key generation and stored with the secret key. During a secret-key operation (i.e., decapsulation in case of Kyber or signing in case of Dilithium), the checksum is then recomputed and tested against these previously stored checksum bits.

The fault-detection capabilities of this approach depend on the used PRNG and on the position of the check bits. As indicated, Kyber and Dilithium use SHAKE as PRNG: SHAKE is an extendable output function belonging to the SHA-3 family of algorithms. SHAKE is described in FIPS PUB 202 [Nat15]. It is a cryptographic sponge construction, which means that a so-called absorption phase is followed by a so-called squeezing phase.

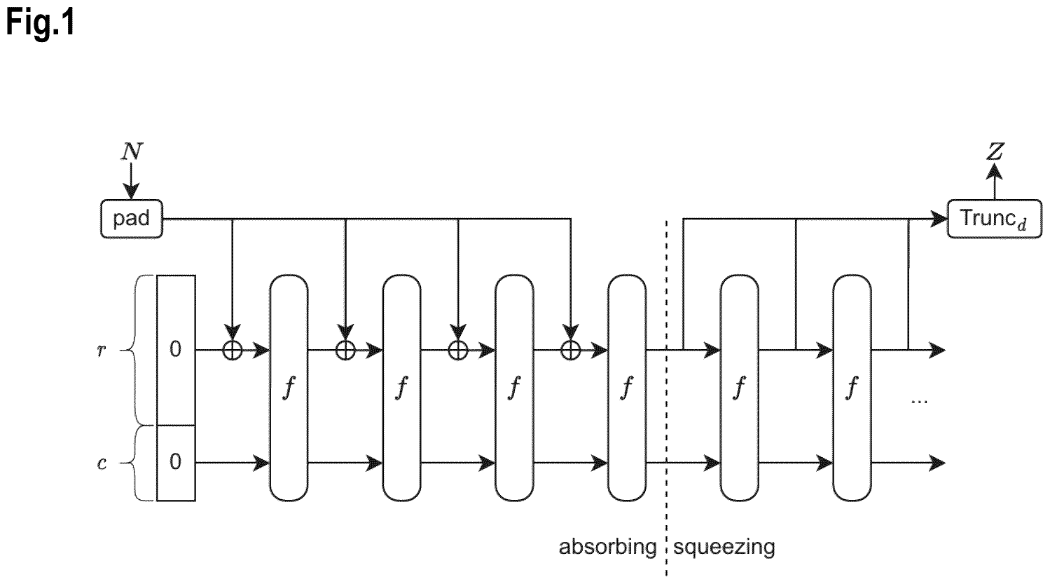

FIG. 1 shows a schematic diagram of states of a Sponge construction of SHAKE according to [Nat15]. The input N is first padded to a multiple of the block length r. Each such block is XOR-ed to a part of the state. After each XOR of a block, a function ƒ is applied to the respective state, which leads to a step-wise absorption of the input N based on operations of previous blocks. After the entire input N is absorbed, an output Z of a length d is extracted in blocks, wherein after each block extraction of r bits, the function ƒ is applied.

To generate the matrix \vec{A} (in Kyber or Dilithium), the input N is set to the seed ρ. The output Z is fed to a sampling algorithm turning the random bits into samples of the desired distribution. The required output length d is not known a priori. Instead, block extraction runs in the squeezing phase as long as the required number d of output bits is generated. In other words, during the squeezing phase, with each application of the function ƒ, a number of r bits are generated. This can be done until a sufficient number of bits are available.

The parameter c is a security parameter: The larger the parameter c, the higher the level of security.

According to an example, SHA-3/SHAKE uses states, which each has a fixed size of 1600 bits, i.e. r+c=1600 bits. The actual sizes of r and c may depend on the particular use-case. The parameter r is also referred to as “rate” and the parameter c as “capacity”.

Examples described herein suggest determining e additional check bits Y by utilizing the PRNG, which are then used for fault detection purposes.

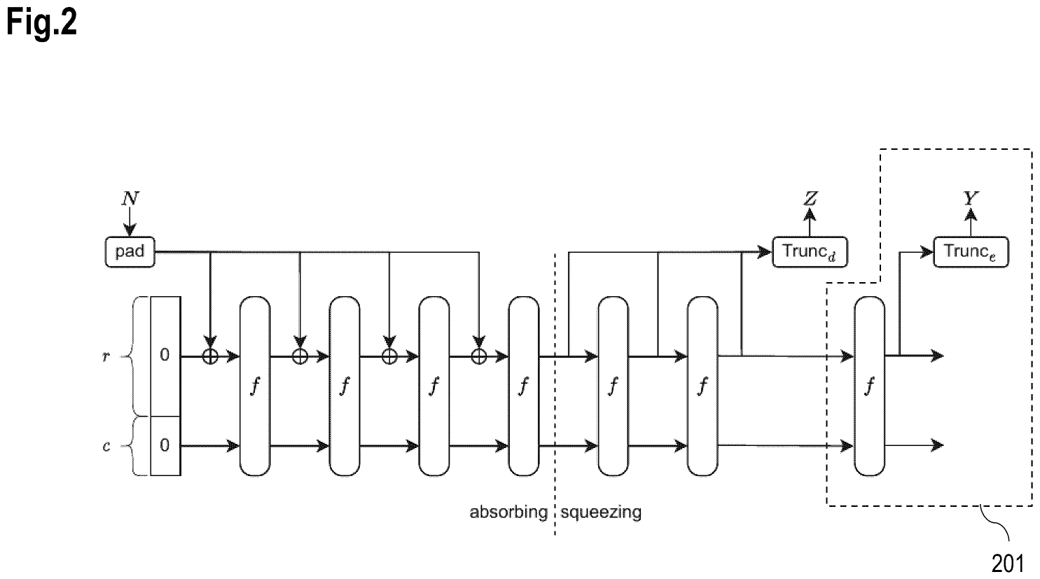

FIG. 2 shows an exemplary embodiment of determining and utilizing e additional check bits Y: After all bits required for the output Z are determined, the function ƒ is called (at least) one more time on the current (latest) state, which results in an additional block of e check bits Y. Utilizing the check bits Y allows detecting faults with a high probability, i.e., fails to detect faults within the function ƒ with a probability of merely 2^{-e}. The check bits Y are determined within a block 201 that is added compared to the example shown in FIG. 1.

This procedure may be first performed during key generation, the check bits Y could then be stored as part of the private key. During secret-key operations, the procedure can be repeated and the check bits Y can be tested against the previously stored values.

In Kyber and Dilithium, each matrix entry is a polynomial, each such polynomial is generated using a separate call to SHAKE, e.g., of the form SHAKE (ρ, matrix index). Thus, separate check bits may have to be stored for each such call of SHAKE.

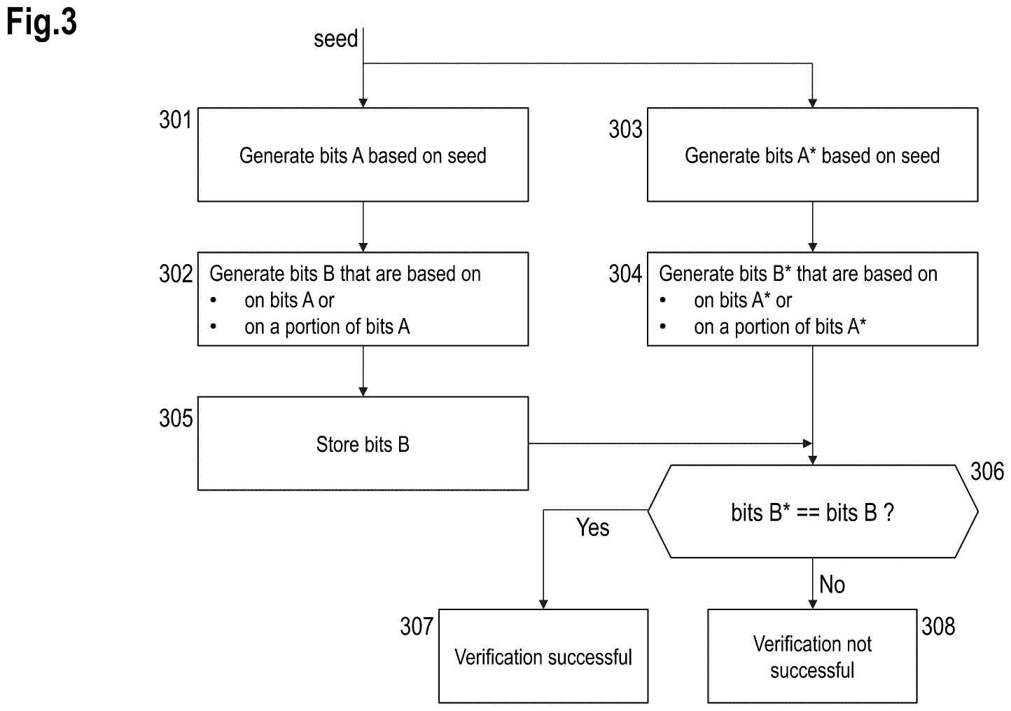

FIG. 3 shows an exemplary diagram visualizing steps of how an integrity of a long bit string can be verified. A seed is fed to a step 301 which allows a generator to generate (e.g., in several steps of an absorbing phase and a following squeezing phase) several bits A based on this seed. Next, in a step 302, bits B can be determined according to one of the following approaches:
1) The bits B are determined in a subsequent step (i.e. function call f). Hence, the bits B are based on all the previous bits, in particular the previously generated bits A.
2) The bits B are taken from the last function call that also contributed to the remaining bits A. Hence, this recent function call resulted in more bits than necessary for the bits A. Some or all of these surplus bits can be used as bits B.
3) A first portion of the bits B is determined according to the approach 2) and a second portion of the bits B is determined according to the approach 1), i.e., in a subsequent function call ƒ. This may be useful, if more bits than the first portion of bits are required.

In a step 305, the bits B are stored. This can be done together with the bits A or without the bits A.

In a step 303, bits A* are generated based on the seed and in a step 304, bits B* are generated. These generation steps 303 and 304 works similar to the steps 301 and 302. All the steps 301 to 304 are preferably run on a generator and/or may use the same generating algorithm.

In a step 306, the stored bits B and the bits B* are compared with each other. If they are identical, the verification of the integrity of the generator is successful (step 307), otherwise the verification is not successful (step 308).

It is noted that the bits B and the bits B* may also be referred to as check bits. It is further noted that the term bits X “are based on” bits Y may include an iterative utilization of a function, wherein each (intermediate) function call utilizes the output of the previous function call. Hence, the bits X can be regarded as (direct or indirect) input to derive the bits Y in several steps, wherein each step (e.g., function call) may provide a portion of the bits Y.

In the example of FIG. 2, the bits Z are “squeezed” out of the input bits N by applying the function ƒ several times. The output of each function call is utilized as input for the subsequent function call. Insofar, the bits Z are based on the input N as well as all the intermediate results of the function calls. Hence, the check bits Y (according to FIG. 2) are based on the input N as well as the bits Z.

### Further Examples and Embodiments

A generic approach for integrity protection comprises multiple computations of the same operation. For example, a particular operation can be performed twice and the output is checked for equivalence. The solution presented herein can be used in this context accordingly. The check bits of the two operations can be tested. It is another option that unused bits, i.e., bits of the last block that extend beyond the mere output Z define the check bits Y. This may result in an even cheaper solution, but certain faults of the last squeezing phase may not be detected. This may in particular apply in case SHAKE is used as a PRNG.

The approach presented herein is not limited to the re-compilation of the matrix \vec{A}. Instead, this solution may be applicable in case random data is (re-) generated from a seed. Such seed may in particular be known in advance and in may optionally be constant.

For example, Kyber as well as Dilithium both utilize a key-pair generation based on a (secret) random seed. The remaining steps of the key-pair generation, however, including the re-compilation of the entire private key then runs deterministically and (only) depends on this initial seed.

In scenarios with limited memory for storing private keys, an approach may be to only store the secret seed used for key generation and re-use this seed to regenerate the (private) key when needed. Such (re-) generation involves running the PRNG (SHAKE) with a fixed secret seed according to the solution described herein.

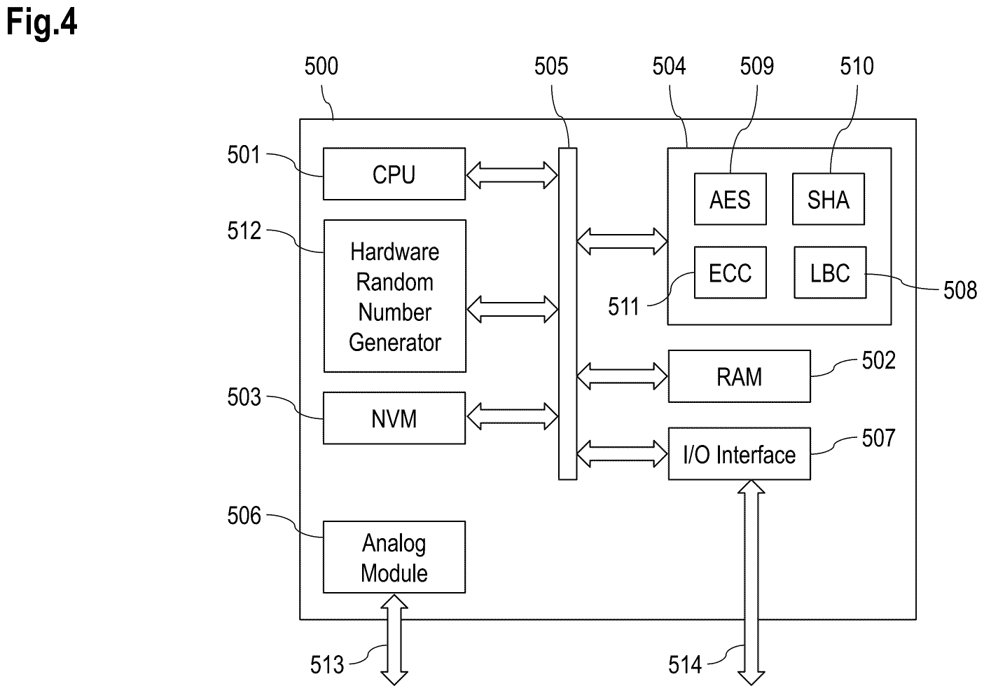

FIG. 4 shows a processing device 500 comprising a CPU 501, a RAM 502, a nonvolatile memory 503 (NVM), a crypto module 504, an analog module 506, an input/output interface 507 and a hardware-random number generator 512. In this example, the CPU 501 has access to at least one crypto module 504 over a shared bus 505 to which each crypto module 504 is coupled. Each crypto module 504 may in particular comprise one or more crypto cores to perform certain cryptographic operations. Exemplary crypto cores are: an AES core 509, a SHA core 510, an ECC core 511, and a lattice-based crypto core 508.

The CPU 501, the hardware random number generator 512, the NVM 503, the crypto module 504, the RAM 502 and the input/output interface 507 are connected to the bus 505. The input output interface 507 may have a connection to other devices, which may be similar to the processing device 500. The crypto module 504 may or may not be equipped with hardware-based security features.

The bus 505 itself may be masked or plain. Instructions to process the steps described herein may in particular be stored in the NVM 503 and processed by the CPU 501. The data processed may be stored in the NVM 503 or in the RAM 502. Supporting functions may be provided by the crypto modules 504 (e.g., expansion of pseudo random data).

Steps of the method described herein may exclusively or at least partially be conducted on the crypto module 504, e.g. on the lattice-based crypto core 508. The processing device 500 may be a chip card powered by direct electrical contact or through an electro-magnetic field. The processing device 500 may be a fixed circuit or based on reconfigurable hardware (e.g., Field Programmable Gate Array, FPGA). The processing device 500 may be coupled to a personal computer, microcontroller, FPGA or a smart phone.

The solution described herein may be used by a customer that intends to provide a secure implementation of lattice-based cryptography on a smart card or any secure element.

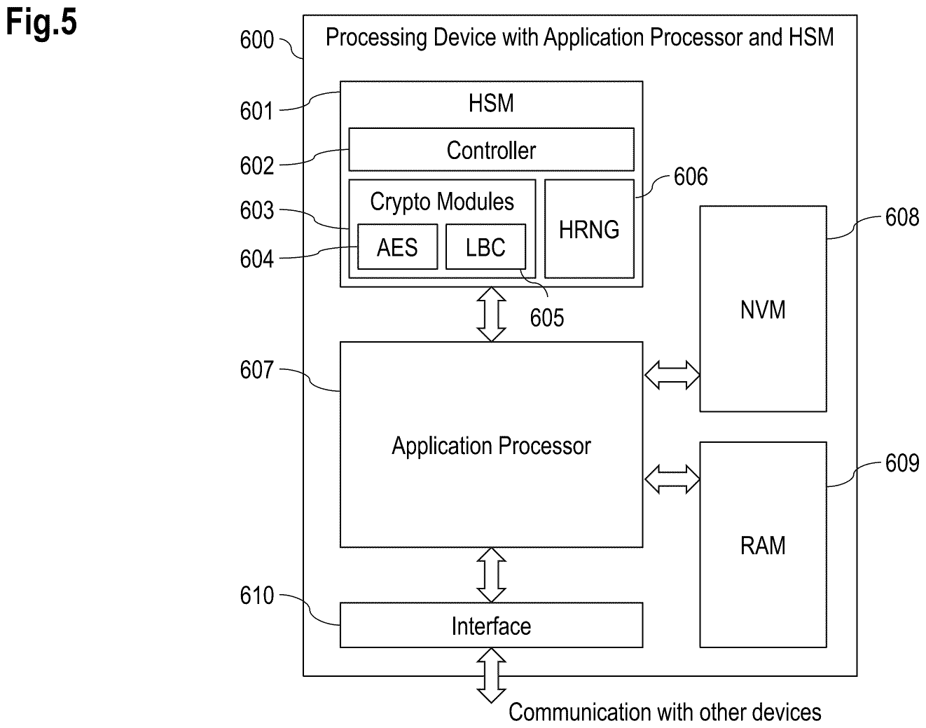

FIG. 5 shows another example of a processing device 600. The processing device 600 comprises a hardware security module 601, a non-volatile memory (NVM) 608, a random access memory (RAM) 609, an interface 610 for communication with other devices and an application processor 607, which is coupled with the hardware security module (HSM) 601, the RAM 609, the NVM 608 and the interface 610.

The HSM 601 comprises a controller 602, a hardware-random number generator (HRNG) 606 and at least one crypto module 603. The crypto module 603 exemplary comprises an AES core 604 and a lattice-based crypto (LBC) core 605. According to one embodiment, the HSM 601 and the application processor 607 may be fabricated on the same physical chip with a tight coupling. The HSM 601 delivers cryptographic services and secured key storage while the application processor may perform computationally intensive tasks (e.g., image recognition, communication, motor control). The HSM 601 may be only accessible by a defined interface and considered independent of the rest of the system in a way that a security compromise of the application processor 607 has only limited impact on the security of the HSM 601. The HSM 601 may perform all tasks or a subset of tasks described with respect to the processing device 600 by using the controller 602, the LBC 605, supported by, exemplary, an AES 604 and the HRNG 606. It may execute the procedures described herein (at least partially) either controlled by an internal controller or as CMOS circuit. Moreover, also the application processor 607 may perform the procedures described herein (at least partially, e.g., in collaboration with the HSM 601). The processing device 600 with this application processor 607 and HSM 601 may be used as a central communication gateway or (electric) motor control unit in cars or other vehicles.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

### REFERENCES

[ABD+21] Roberto Avanzi, Joppe Bos, Léo Ducas, Eike Kiltz, Tancrède Lepoint, Vadim Lyubashevsky, John M. Schank, Peter Schwabe, Gregor Seiler, and Damien Stehlé. CRYSTALS-Kyber: Algorithm specification and supporting documentation (version 3.02). Submission to the NIST Post-Quantum Cryptography Standardization Project [NIS16], 2021. Specification Document: https://pq-crystals.org/kyber/data/kyber-specification-round3-20210804.pdf. Website: https://pq-crystals.org/kyber.
[LDK+21] Vadim Lyubashevsky, Léo Ducas, Eike Kiltz, Tancrède Lepoint, Peter Schwabe, Gregor Seiler, and Damien Stehlé. CRYSTALS-Dilithium: Algorithm specification and supporting documentation (version 3.1). Submission to the NIST Post-Quantum Cryptography Standardization Project [NIS16], 2021. Specification Document: https://pq-crystals.org/dilithium/data/dilithium-specification-round3-20210208.pdf. Website: https://pq-crystals.org/dilithium.
[Nat15] National Institute of Standards and Technology. FIPS 202, SHA-3 Standard: Permutation-Based Hash and Extendable-Output Functions, 2015. Available at: https://nvlpubs.nist.gov/nistpubs/FIPS/NIST.FIPS.202.pdf.
[NIS16] NIST Computer Security Division. Post-Quantum Cryptography Standardization, 2016. Website: https://csrc.nist.gov/Projects/Post-Quantum-Cryptography.

1. A method for generating a sequence of bits based on a seed,
wherein a generator is utilized to generate a first set of bits based on the seed,
wherein the generator is used to generate a second set of bits, wherein the second set of bits is based on the first set of bits or on a portion of the first set of bits, and
wherein the sequence of bits comprises the first set of bits and the second set of bits.

2. The method according to claim 1, wherein the generator operates in cycles, wherein each cycle depends on the previous cycle and utilizes a function ƒ.

3. The method of claim 1, wherein the generator is a pseudo-random-number generator (PRNG), which utilizes an absorbing phase absorbing the seed and a squeezing phase determining the first set of bits and the second set of bits.

4. The method of claim 1, wherein SHAKE is used as the PRNG.

5. The method of claim 1, wherein the second set of bits are checksum bits to verify the sequence of bits.

6. The method of claim 5, wherein the sequence of bits is verified by re-calculating the second set of bits based on the seed and comparing these re-calculated second set of bits with the checksum bits.

7. The method of claim 1, wherein the second set of bits is computed during a key generation and stored together with the key.

8. The method of claim 1, wherein the method is used in the context of a lattice-based cryptography method.

9. The method of claim 1, wherein the sequence of bits is determined to compile a matrix for a key pair used in Kyber or Dilithium.

10. The method of claim 1, wherein the method is at least partly conducted on one of the following:
a security device,
a secured cloud,
a secured service,
an integrated circuit,
a hardware security module,
a trusted platform module,
a crypto unit,
a FPGA,
a processing unit,
a controller,
a smartcard.

11. A device for generating a sequence of bits based on a seed, wherein the device is arranged to execute the following steps:
generating a first set of bits based on the seed,
generating a second set of bits, wherein the second set of bits is based on the first set of bits or on a portion of the first set of bits, wherein the sequence of bits comprises the first set of bits and the second set of bits.

12. The device of claim 11, wherein the device is one of the following or it comprises at least one of the following:
a security device,
a secured cloud,
a secured service,
an integrated circuit,
a hardware security module,
a trusted platform module,
a crypto unit,
a FPGA,
a processing unit,
a controller,
a smartcard.

13. A non-transitory computer-readable medium comprising software code directly loadable into a memory of a digital processing device, the software code comprising software code portions for performing the steps of the method of claim 1.
